(19) United States
(12) Patent Application Publication
(10) Pub. No.: US 2015/0044023 A1
(43) Pub. Date: Feb. 12, 2015

(54) EXHAUST-GAS TURBOCHARGER

(71) Applicant: BorgWarner Inc., Auburn Hills, MI (US)

(72) Inventors: Guido Schlarb, Hahnenbach (DE); Ulrich Maas, Eppelsheim (DE)

(21) Appl. No.: 14/380,733

(22) PCT Filed: Feb. 21, 2013
(86) PCT No.: PCT/US2013/027066

§ 371 Date: Aug. 25, 2014

(30) Foreign Application Priority Data
Mar. 6, 2012 (DE) 102012004623.5

(51) Int. Cl. F04D 29/66; F02B 37/22

(52) U.S. Cl. CPC F04D 29/663; F02B 37/225
USPC 415/11

(57) ABSTRACT

An exhaust-gas turbocharger (1), having a turbine (2) and a compressor (3) which is connected to the turbine (2) via a bearing housing (4) and which has a compressor housing (5). The compressor housing has a valve flange (6), provided with a valve seat (11), for an overrun air recirculation valve and has a connecting duct (9) which opens out at one end (9A) in a compressor inlet (7), a valve flange chamber (14) into which the other end (9B) of the connecting duct (9) opens out being arranged between a valve orifice (10) of the valve flange (6) and a valve seat orifice (13) of the valve seat (11). The valve flange chamber (14) is provided with a buffer volume (15).

The invention relates to an exhaust-gas turbocharger as per the preamble of claim 1.

In supercharged applied-ignition engines in which the generic turbocharger may be used, the throttle flap which serves to predefine the engine load is fitted, downstream of the compressor of the turbocharger, in the air manifold. When the accelerator pedal is released, the throttle flap closes and the compressor of the turbocharger would, owing to its mass inertia, deliver air against a virtually closed volume. This would have the result that the compressor could no longer deliver continuously, and backflows would form. The compressor would surge. The rotational speed of the turbocharger would therefore decrease very suddenly. To prevent this, turbochargers may be provided with an air recirculation valve (also referred to as overrun air recirculation valve) which, beyond a certain negative pressure, opens a connecting duct by means of a spring-loaded valve element, which connecting duct recirculates the air to the compressor inlet. It is thus possible for the rotational speed of the turbocharger to remain at a high level and for charge pressure to be immediately available again in the event of a subsequent acceleration process.

Tests carried out within the context of the invention have however shown that, in turbochargers that are provided with overrun air recirculation valves of said type, acoustic problems arise owing to disturbing induction noises caused by cavity resonance. It has duly been attempted, in part, to eliminate said acoustic problems through the provision of resonators in the intake region of a vehicle provided with a generic turbocharger, but this self-evidently increases the outlay in terms of construction.

It is therefore an object of the present invention to provide an exhaust-gas turbocharger of the type specified in the preamble of claim 1, which exhaust-gas turbocharger prevents the generation of disturbing noises owing to the described cavity resonance.

Said object is achieved by means of the features of claim 1.

The buffer volume provided according to the invention yields a considerable acoustic improvement in the operating behavior of the exhaust-gas turbocharger according to the invention, because the disturbing compressor and induction noises can be either completely eliminated or at least considerably reduced. The buffer volume constitutes a special volume enlargement on the compressor housing in the region of the overrun air recirculation valve, which volume enlargement can be described as an asymmetrical volume enlargement because the buffer volume is arranged somewhere on the circumference of the valve flange of the overrun air recirculation valve, which means that there is a locally concentrated enlargement of the volume on the circumference.

Said measure may be provided either for pneumatically actuated compressor housing overrun air recirculation valves or for electrically actuated compressor housing overrun air recirculation valves.

Accordingly, it is possible for vehicle manufacturers to eliminate the abovementioned resonators in the intake region of the vehicle. The overall result is an improvement of the NVH rating of the corresponding vehicles.

The subclaims relate to advantageous refinements of the invention.

Further details, advantages and features of the present invention will emerge from the following description of exemplary embodiments on the basis of the drawing, in which:

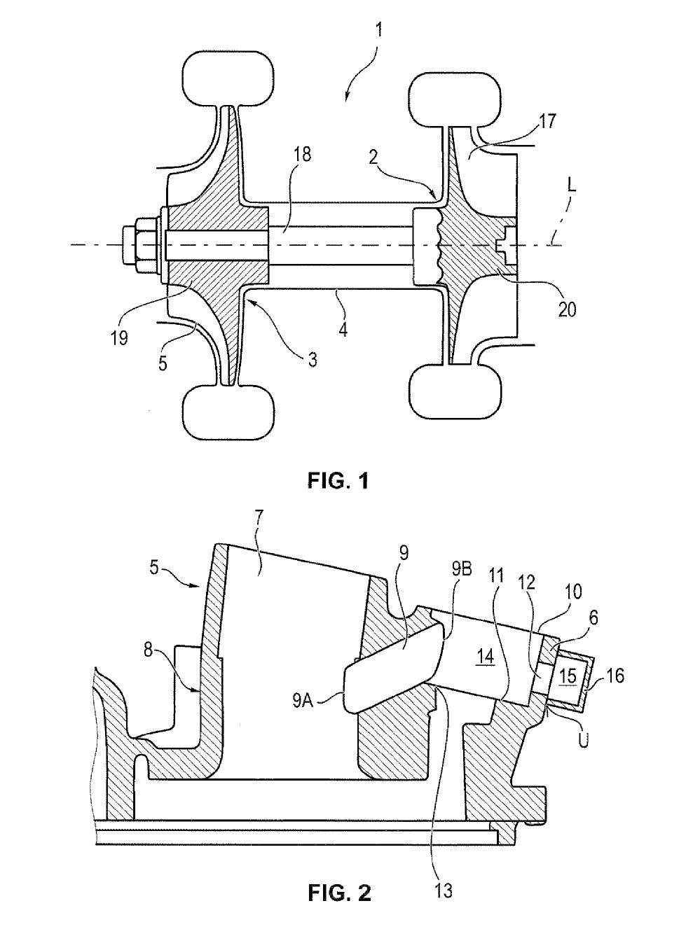

FIG. 1 is a schematically highly simplified illustration of an exhaust-gas turbocharger according to the invention,

FIG. 2 is a sectional illustration through the compressor housing in the region of the compressor inlet together with the valve flange for an overrun air recirculation valve,

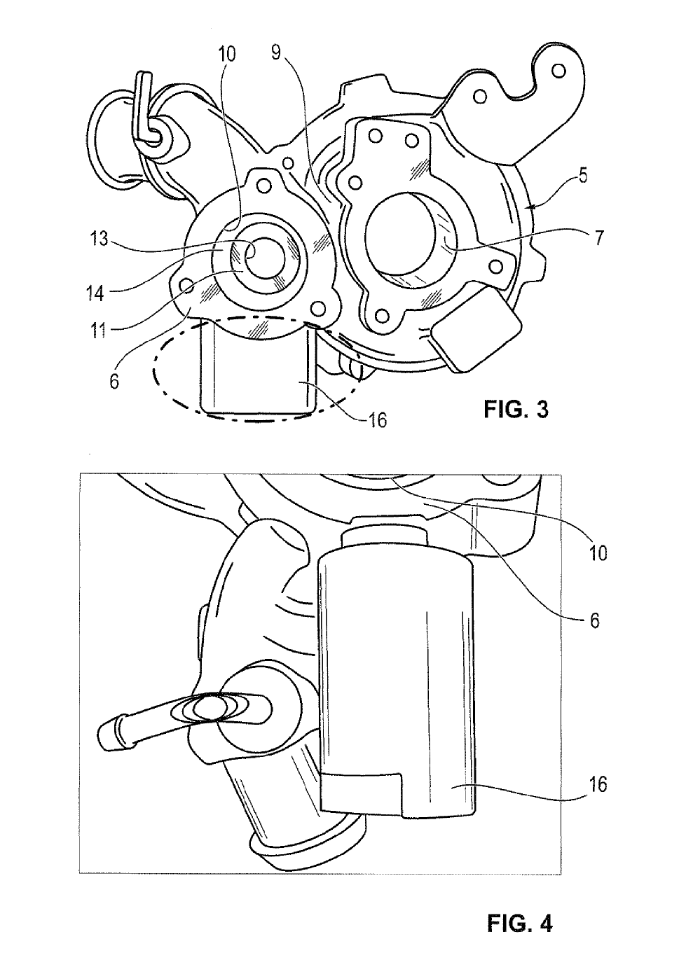

FIG. 3 shows a plan view of the compressor housing from the view of the compressor inlet,

FIG. 4 shows a partial view of the compressor housing with an alternative design of a vessel for a buffer volume, and

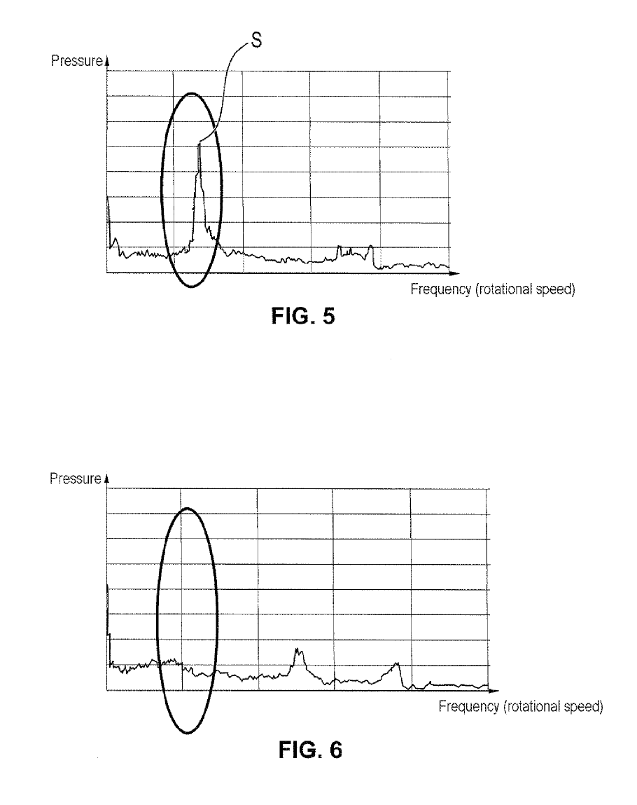

FIGS. 5, 6 show graphs illustrating the acoustic effect of the measures according to the invention (FIG. 6) in comparison with the acoustic effects of known turbochargers (FIG. 5) without the measures according to the invention.

FIG. 1 is a schematically highly simplified illustration of the basic design of the exhaust-gas turbocharger 1 according to the invention. Said exhaust-gas turbocharger has a turbine 2 with a turbine housing 17 and has a compressor 3 with a compressor housing 5. The housings 5 and 17 are connected to one another by means of a bearing housing 4 in which is mounted a shaft 18 which bears a compressor wheel 19 on one end and a turbine wheel 20 on the opposite end.

FIG. 2 shows a section through the compressor housing 5 which has a compressor inlet 7. On the compressor housing 5 there is integrally formed a valve flange 6 which is provided for the arrangement of an overrun air recirculation valve, which is however not illustrated in FIG. 2 as it is not required for explaining the principles of the present invention.

The valve flange 6 has a valve orifice 10 and a valve seat 11 which has a valve seat orifice 13. As shown in FIG. 2, there is arranged between the valve orifice 10 and the valve seat orifice 13 a valve flange chamber 14 whose internal diameter is greater than the internal diameter of the valve orifice 13, such that the valve flange chamber 14 rotationally symmetrically surrounds the valve orifice 13. The valve flange chamber 14 is connected via a connecting duct 9 to the compressor inlet 7 of the compressor housing 5. For this purpose, one end 9A of the connecting duct 9 opens out into the compressor inlet 7 and the other end 9B of the connecting duct 9 opens out into the valve flange chamber 14. It is thus possible, for the prevention of surging of the compressor, for air to flow via the connecting duct 9 back to the compressor inlet 7 when the valve seat orifice 13 is open.

To avoid the acoustic problems explained in the introduction, there is provided according to the invention a buffer volume 15 which is provided somewhere on the circumference U of the valve flange 6 as a concentrated volume enlargement. Said arrangement is referred to according to the invention as an asymmetrical volume enlargement because, by contrast to a continuous enlargement of the entire valve flange chamber 14, it is a concentrated volume enlargement at a selectable location on the circumference U of the valve flange chamber 14 or of the valve flange 6.

In the embodiment illustrated in FIG. 2, the buffer volume is arranged in a vessel 16, wherein a connecting recess 12 in the wall of the valve flange 6 connects the buffer volume 15 to the valve flange chamber 14. There are various possibilities for the arrangement of the vessel 16 on the valve flange 6. In the embodiment illustrated in FIG. 3, the vessel 16 is welded to the valve flange 6 and, in the alternative embodiment illustrated in FIG. 4, the vessel 16 is screwed to the valve flange 6. It is however also possible for the vessel 6 to be integrated in the valve flange, for example by means of a casting process.

It is also conceivable for the vessel 16 to be fixed by means of an adhesive connection.

The size of the buffer volume 15 is between approximately 10 cm³ and 20 cm³ depending on how large the diameter of the valve seat 11 or of the valve seat orifice 13 is.

FIGS. 5 and 6 show the effect of the measures according to the invention. Here, FIG. 5 shows the pressure/frequency diagram of a known exhaust-gas turbocharger, the graph of which shows a peak S highlighted by the oval outline, which peak leads to the acoustic problems explained in the introduction.

By contrast, FIG. 6 shows the same diagram of a graph of an exhaust-gas turbocharger according to the invention, which no longer exhibits the peak S in the region highlighted by the oval outline. This smoothing of the curve represents the acoustic improvement resulting from the provision of the buffer volume 15 explained above.

To supplement the disclosure in addition to the written description of the invention above, reference is hereby explicitly made to FIGS. 1 to 6.

### LIST OF REFERENCE SYMBOLS

1 Turbocharger
2 Turbine
3 Compressor
4 Bearing housing
5 Compressor housing
6 Valve flange
7 Compressor inlet
8 Suction connecting piece
9 Connecting duct
9A,B End of the connecting duct 9
10 Valve orifice
11 Valve seat
12 Connecting recess
13 Valve seat orifice
14 Valve flange chamber
15 Buffer volume
16 Vessel
17 Turbine housing
18 Shaft
19 Compressor wheel
20 Turbine wheel
L Turbocharger longitudinal axis
S Pressure peak

1. An exhaust-gas turbocharger (1), having
a turbine (2) and
a compressor (3) which is connected to the turbine (2) via a bearing housing (4) and which has a compressor housing (5), which compressor housing has a valve flange (6), provided with a valve seat (11), for an overrun air recirculation valve and has a connecting duct (9) which opens out at one end (9A) in a compressor inlet (7), a valve flange chamber (14) into which the other end (9B) of the connecting duct (9) opens out being arranged between a valve orifice (10) of the valve flange (6) and a valve seat orifice (13) of the valve seat (11), wherein
the valve flange chamber (14) is provided with a buffer volume (15).

2. The exhaust-gas turbocharger as claimed in claim 1, wherein the valve flange chamber (14) rotationally symmetrically surrounds the valve seat orifice (13) and has a larger internal diameter than the valve seat orifice (13).

3. The exhaust-gas turbocharger as claimed in claim 1, wherein the buffer volume (15) is arranged as a locally concentrated volume enlargement on the circumference (U) of the valve flange (6).

4. The exhaust-gas turbocharger as claimed in claim 1, wherein the buffer volume (15) is arranged in a vessel (16) which is mounted on the valve flange (6).

5. The exhaust-gas turbocharger as claimed in claim 4, wherein the vessel (16) is integrated in the valve flange (6).

6. The exhaust-gas turbocharger as claimed in claim 4, wherein the vessel (16) is welded to the valve flange (6).

7. The exhaust-gas turbocharger as claimed in claim 4, wherein the vessel (16) is adhesively bonded to the valve flange (6).

8. The exhaust-gas turbocharger as claimed in claim 4, wherein the vessel (16) is screwed to the valve flange (6).

9. The exhaust-gas turbocharger as claimed in claim 1, wherein the buffer volume (15) has a size of approximately 10 cm³ to 20 cm³.

10. The exhaust-gas turbocharger as claimed in claim 1, wherein the overrun air recirculation valve is a pneumatically actuated or electrically actuated valve.
